(19) United States
(12) Patent Application Publication
(10) Pub. No.: US 2011/0005151 A1
(43) Pub. Date: Jan. 13, 2011

(54) Low-energy building, particularly greenhouse or stabling

(76) Inventor: Edmond D. Krecke, Wiesbaden (DE)

Correspondence Address: DeMont & Breyer, LLC, 100 Commons Way, Ste. 250, Holmdel, NJ, 07733, US

(21) Appl. No.: 12/865,254

(22) PCT Filed: Jan. 29, 2009
(86) PCT No.: PCT/EP2009/000564

§ 371 Date: Sep. 27, 2010

(30) Foreign Application Priority Data
Feb. 1, 2008 (DE) 20 2008 001 537.5

(51) Int. Cl. E04H 14/00; F28D 7/10; F24F 11/00; F24J 3/08; F25B 29/00; A01G 9/14

(52) U.S. Cl. 52/173.1; 165/154; 454/238; 165/45; 165/48.1; 47/17

(57) ABSTRACT

A building is disclosed, with which the air may be guided from a heat reservoir into an interspace, and/or from the interspace into the heat reservoir through conduits.

### FIELD OF THE INVENTION

The invention relates to a low-energy building, preferably formed as greenhouse, or stabling. In particular, the invention relates to a greenhouse, a stabling, or a fish farm formed as zero-energy building.

### BACKGROUND OF THE INVENTION

Low-energy houses, and zero-energy houses are known. Particularly, buildings are known, which have building wall with fluid lead-throughs, by means of which a temperature barrier may be formed. The German patent application publication DE 298 04 095 A1 (inventor: Edmond D. Krecke) for example shows such a low-energy house. Zero-energy houses may even be provided in northern degrees of latitude by means of a geothermal heat reservoir, which is loaded during summer, and unloaded during winter, as well as by means of temperature barriers consisting of fluid conduits arranged in the walls.

It is a disadvantage of this known technology that it cannot or only unsufficiently be transferred to commercial buildings with large glass surfaces, like stablings, and greenhouses.

Despite the low temperatures often prevailing in those buildings, high amounts of energy are necessary to keep the inner space of the building on the wanted temperature level, due to the thermal insulation often being poor just in the case of large buildings. When doing, it is mostly reverted to using fossil energy carrier.

### OBJECT OF THE INVENTION

In contrast, the invention is based on the object to lower the mentioned disadvantages of the state of the art.

In particular, it is an object of the invention to provide even large buildings with large glass surfaces like stablings, and greenhouses with a system, which uses the radiation energy of the sun in an especially easy manner to make heating the building in cold spells possible.

### SUMMARY OF THE INVENTION

Accordingly, a building is provided, which comprises wall windows, or rooflights made from a transparent material, being at least in sections double. Preferably, the building is for example formed as greenhouse, mainly made from transparent material like glass, plastics, in particular plastic foil, etc. An interspace is defined by the double windows. In particular, the building is formed for producing animals or plants, and for example is a greenhouse, a stabling, in particular for intensive mass animal farming, or a fish farm.

Furthermore, the building has at least one heat reservoir, which is preferably formed as geothermal heat reservoir arranged below, or besides the building.

Furthermore, a conduit is provided, via which the air may be guided from the heat reservoir into the interspace and/or from the interspace into the heat reservoir.

In case of incident solar radiation, particularly during summer, the air between the windows heats up, the heat being generated may be stored in a thermal heat reservoir. Preferably, this takes place by means of a cycle with which the air cools down in the heat reservoir, and the then cooler air is guided back into the interspaces.

If necessary, fresh air from the outside may alternatively be fed in for tempering. Basically, however, a temperature stabilization is already achieved by a cycle, because the air between the windows heats strongly up in case of incident solar radiation so that it is essentially warmer than the temperature in the heat reservoir. The warm air is guided through the heat reservoir, wherein a heat exchange extracting heat from the air is caused. The so cooled air again flows back into the interspaces, and lowers the temperature between the windows, by what an overheating of the whole building is avoided, particularly during summer.

In cold spells, particularly during winter, the temperature in the heat reservoir arranged under the house in contrast is higher than the temperature in the interspaces so that the air heats up when being guided through the heat reservoir, and the temperature in the interspaces increases.

With respect to the interior space of the building, the interspaces so form a temperature barrier making sure that, seen from the inside, the temperature difference to the interspace is stabilized.

With a further embodiment of the invention, the building comprises at least one further conduit for guiding fresh via the heat reservoir into the building. Depending on the temperature of the heat reservoir, and on the temperature of the building, the heat reservoir so may be used also to heat up, or to cool down the air in the building.

With a further embodiment of the invention, used air may be guided via a further conduit out of the building via the heat reservoir. If the temperature in the building is higher than the temperature in the heat reservoir, the heat being in the building may so be used to heat up the heat reservoir.

In doing so, the conduits are preferably formed as pipe-in-pipe heat exchanger, wherein the used air is guided out via an inner pipe, in case of the preferred embodiment of the invention, which pipe is at least in sections guided through an outer pipe, via which the fresh air is guided into the building.

In the heat reservoir, the conduits for guiding in the fresh air, and for guiding out the used air are preferably arranged at least in sections above the conduit, which is connected with the interspaces of the windows, because here the temperature in the heat reservoir is normally higher.

To be able for adapting to warm and cold spells, at least one, preferably all conduits have means for reversing the air flow in the conduits.

With a further embodiment of the invention, a jalousie is arranged in at least one interspace. In case of strong incident solar radiation, the heating up in the inner space of the building may be reduced by means of the jalousie. At the same time, the interspace in the window provided with the jalousie exceptionally heats up due to absorbing the solar light at the jalousie. This heat may in turn be used for heating up the heat reservoir.

For controlling air humidity, particularly during winter, the building has a humidifier for fresh air, in case of a further embodiment of the invention.

During the whole year, the temperature in the heat reservoir is above 15° C., preferably above 18° C.

With a further embodiment of the invention, a heat pump is provided, which may be fed with air being guided via the heat reservoir. Depending on the insulation of the building, the necessary heat for heating the inner space may be provided via such a heat pump, at least in extreme cold spells.

Furthermore, the invention relates to a method for deairing, and aeration of buildings, in particular of greenhouses, wherein a temperature barrier is provided in the light-transmissive outside wall of the walls, and of the roof. When doing so, a separate piping system is provided, in order to lead away excess heat by means of air conduits in times of much incident solar radiation, and to store the excess heat in a heat reservoir, preferably a terrestrial reservoir. During cold spells, this energy may be sued for tempering the building, either by feeding into the interspaces, or for heating the inner space.

In this manner, a considerable saving of heat may be achieved, even in case of badly insulated buildings like greenhouses, and stablings. Depending on the climate zone, even zero-energy greenhouses may be provided.

When doing so, the heat reservoir is preferably formed as terrestrial heat reservoir with pipe-in-pipe heat exchangers operating according to the counter flow principle. Preferably, the terrestrial reservoir is arranged under the building in depth between 2, and 5 m, and at least upwards, and laterally insulated.

The double windows may be made of glass, knob foils, or another light-transmissive material being suited for greenhouses, and are manufactured in sections, and composed to one another in case of a further embodiment of the invention so that segment are formed, from which the air is guided in smaller conduits to an air collection conduit, and from there further to the terrestrial heat reservoir. Preferably, the sections have a width between 50 cm, and 1.50 m, and a height between 50 cm, and 2 m.

With a further embodiment of the invention, the air is conveyed into the interspaces, particularly blown so that with respect to the surrounding an over pressure is in the interspaces. By doing so, for example double windows made from foils may be stabilized. The pressure for feeding the air is comparably low, and stays below 0.1 bar, in case of a preferred embodiment of the invention.

Alternatively, the air may also be drawn out of the interspaces. This embodiment is particularly suited for windows made from glass, or acrylic glass.

The pipe-in-pipe heat exchangers installed in the terrestrial heat reservoir preferably consist of flexible. Metallic pipes, which can easily be installed, and ensure a good heat exchange.

The air speeds for delivery air, and the outgoing air in the pipe-in-pipe aeration, and deairing systems as well as for the conduits to the interspaces may be controlled independently from each other, in case of a preferred embodiment of the invention. Preferably, the controlling takes place continuously.

By means of blowers, exhausters, valves, and adjusting devices, in particular for the lamellae of a jalousie, the system is controlled such that the fresh air supply for a greenhouse may optimally be controlled with respect to the air volumes, and the temperature profiles being necessary for the plants.

In times of high heat radiation, die danger of over heating is intercepted for the plants, and the heat is transported to the terrestrial reservoir. If heating is needed, the heat is guided back.

With a further embodiment of the invention, the terrestrial heat reservoir is divided in different temperature zones. For example, air having a temperature of above 25° C. may so be guided into a core reservoir, air above 20° C., but below 25° C. into a zone extending around the core reservoir, etc. During winter for example, the outer zone having a lower temperature may be used for tempering the interspaces, while the core zone is used for heating the inner space of the building.

Mainly in regions with high incident solar radiation, it is provided with a further embodiment of the invention to let water flowing over the roof, and the side wall on the sides of the building, facing the sun, by means of a sprinkler system, and to collect the heated water, or to fed into a terrestrial heat exchanger, or into the terrestrial heat reservoir, and to guide the cooled down water again to the sprinkler system.

### BRIEF DESCRIPTION OF THE DRAWINGS

In the following, the invention shall be described in more detail, by reference to the drawings FIG. 1 to FIG. 5.

FIG. 1 schematically shows an embodiment of a building according to the invention.

FIG. 2 schematically shows a window element in a lateral view.

FIG. 3 shows windows elements in a top view.

FIG. 4 shows the installation of a pipe.

FIG. 5 shows the installation of the heat exchanger in the terrestrial heat reservoir.

### DETAILED DESCRIPTION

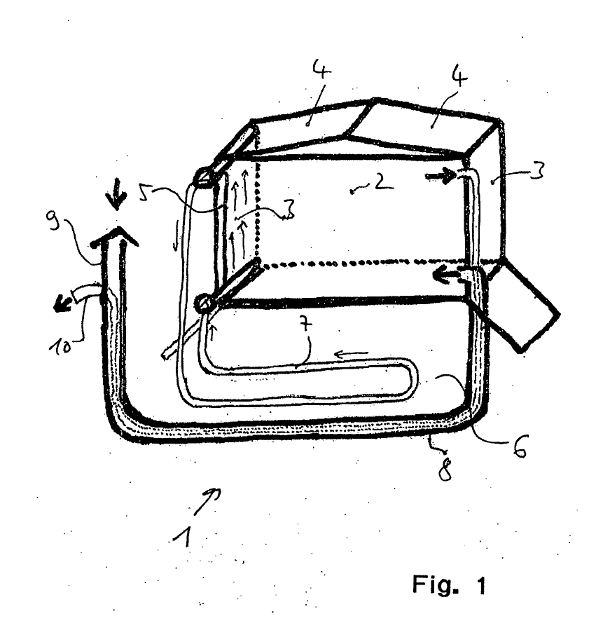

FIG. 1 schematically shows a building 1, which particularly is formed as greenhouse.

The building 1 comprises an inner space 2 which is surrounded by walls 3, and roof areas 4 particularly consisting of windows. Thereby, the walls 3, and the roof areas 4 are formed as double windows made of plastics, plastics foil, or glass. Interspaces 5 are defined by the double windows. Under the building, there is a terrestrial heat reservoir 6 which is connected with the interspace 5 via a conduit 7. Air is pumped out of the terrestrial heat reservoir 6 into the interspaces 5 via the conduit 7. In times of low temperature, the air in the terrestrial heat reservoir 6 is heated, and forms a temperature barrier in the interspaces 5. If, for example, air of 15° C. pumped through the interspaces, this has the effect of the ambient temperature of the building 1, having 15° C., only.

In times of high temperature, the heat may in contrast be led away out of the interspaces 5, whereby the building is cooled, and the terrestrial heat reservoir 6 is loaded up, at the same time.

Additionally to conduit 7, a pipe-in-pipe fresh air, and used air system 8 is provided in the terrestrial heat reservoir 6, with which system fresh air may be fed into the inner space 2 of the building via an outer conduit 9. Used air may be led out of the building via an inner conduit 10 at least in sections being guided in the outer conduit. Inner conduit 10, and outer conduit 9 form a pipe-in-pipe heat exchanger operating according to the counter flow principle. Air which is drawn through the outer conduit may for example be heated in the heat exchanger 6, and so be used for heating the inner space 2. Used air which is leaded out of the inner space 2 may at least partially transfer its heat to the fed in fresh air, in the pipe-in-pipe heat exchanger 8.

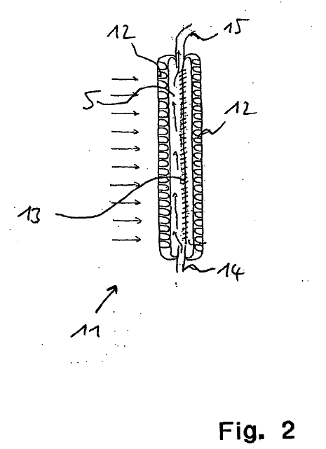

FIG. 2 schematically shows a cut view of a window 11. In this embodiment, the window 11 consists of two knob foils 12. in the interspace 5 between the knob foils 12, a jalousie 13 may be inserted to protect the building (not shown) against incident solar radiation. Solar radiation is now absorbed at the jalousie 13, by what the interspace 5 is strongly heated up. Cold air is fed into the interspace 5 via a feed pipe 13, and led away via a discharge 14, and guided into the terrestrial heat reservoir (not shown).

At the same time, the knob foil 12 is stabilized by the pressure of the air being fed in.

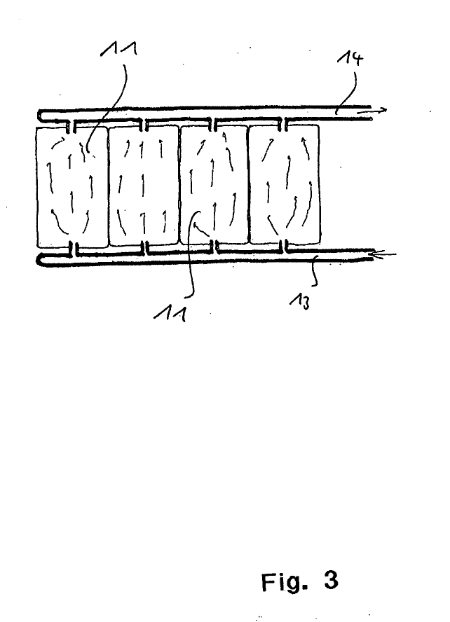

FIG. 3 shows a window 11, or window elements respectively, in a top view.

The individual windows 11 are lined up as segments, and connected with the feed pipe 13 on the one side, and with the discharge 14, on the other side

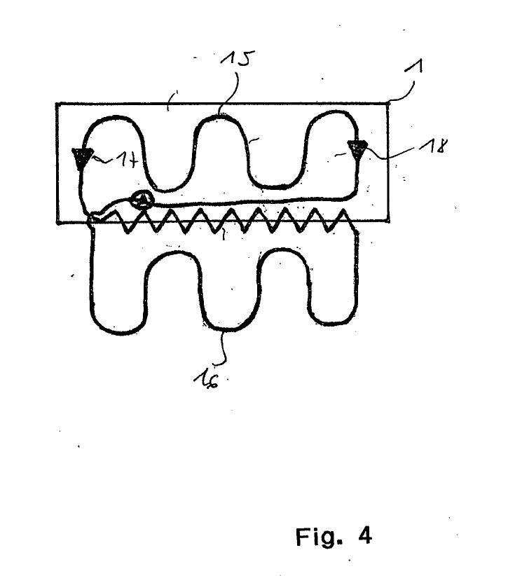

Referring to FIG. 4, the installation of the conduits shall be described.

The conduit section 15 is installed in the terrestrial heat exchanger under the building, and forms a warm cycle having relatively high temperature. For example, temperature of approximately the wanted room temperature.

Besides the warm cycle forming a core zone of the heat reservoir, a further conduit section 16 is provided forming a cold cycle, in which the temperature is lower. The cycle runs in direction of arrow 17 case of winter operation for heating the greenhouse. In case of cooling operation during summer in direction of arrow 18.

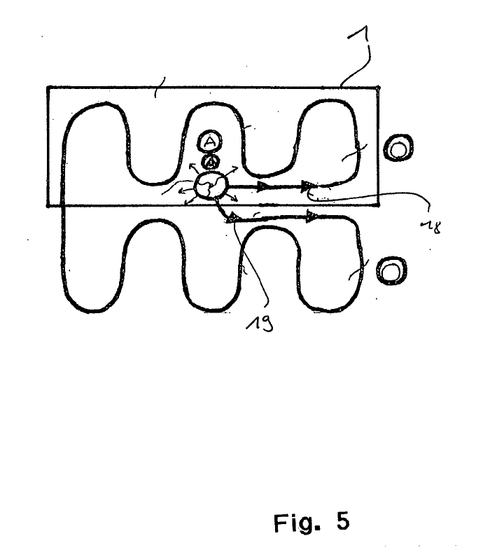

FIG. 5 shows the installation of a pipe-in-pipe heat exchanger for deairing, and aerating a building 1. Also here, there is a warm cycle below the bottom of the building 1, but above the pipe described in FIG. 4, which pipe is connected with the interspaces of the windows (not shown). During summer operation, the air cycle runs in the direction of arrow 18, and during winter operation in the direction of arrow 19. During summer operation, the warm air firstly runs through the core zone of the heat reservoir, and then the colder, outer zone, whereas during winter operation, cold air is firstly heated up in the cold cycle a little bit, and later stronger.

It shall be understood that the invention is not limited to a combination of the above described features, but that the person skilled in the art will combine all features in arbitrary combination, as far as this makes sense.

### REFERENCE SIGNS

1—Building
2—Inner space
3—Wall window
4—Rooflight
5—Interspace
6—Terrestrial heat reservoir
7—Conduit
8—Pipe-in-pipe heat exchanger
9—Outer conduit
10—Inner conduit
11—Window
12—Knob foil
13—Feed pipe
14—Discharge
15—Conduit section
16—Conduit section
17—Arrow
18—Arrow
19—Arrow

What is claimed is:

1. A building comprising wall windows, or rooflights at least in sections double, made from transparent material, defining an interspace, a heat reservoir, and at least one conduit for guiding air from the heat reservoir into the interspace and/or from the interspace into the heat reservoir.

2. The building according to claim 1, further comprising conduits for guiding fresh air via the heat reservoir into the building.

3. The building according to claim 2, further comprising conduits for guiding used air via the heat reservoir out of the building.

4. The building according to claim 3, wherein the conduits are formed as pipe-in-pipe heat exchangers.

5. The building according to claim 2, wherein the conduits for guiding used air and/or the conduits for guiding fresh air are arranged in the heat reservoir above the at least one conduit, via which the used and/or fresh air may be guided from the heat reservoir into the interspace, and/or from the interspace into the heat reservoir.

6. The building according to claim 1, further comprising means for reversing airflow in the conduits.

7. The building according to claim 1, wherein the wall windows are made from glass, transparent plastics, or plastic foil.

8. The building according to claim 1, wherein a jalousie is arranged in the interspace.

9. The building according to claim 1, further comprising a humidifier for fresh air.

10. The building according to claim 1, wherein the temperature in the heat reservoir year-round is greater than 18° C.

11. The building according to claim 1, further comprising a heat pump, which is supplied with air being guided via the heat reservoir.

12. The building according to claim 1, wherein the air is conveyed into the interspaces by a pressure less than 0.3 bar.

13. The building according to claim 12 wherein the air is blown into the interspaces.

14. The building according to claim 12 wherein the pressure is less than 0.2 bar.

15. The building according to claim 14 wherein the pressure is less than 0.1 bar.

16. The building according to claim 1 wherein the heat reservoir is formed to store geothermal heat from under the building.
